(19) United States
(12) Patent Application Publication
(10) Pub. No.: US 2020/0091501 A1
(43) Pub. Date: Mar. 19, 2020

(54) POROUS BINDER-FREE ELECTRODE FILM

(71) Applicant: SABIC Global Technologies B.V., Bergen op Zoom (NL)

(72) Inventors: Yunyang Liu, Thuwal (SA); Ihab N. Odeh, Sugar Land, TX (US)

(21) Appl. No.: 16/471,025

(22) PCT Filed: Jan. 4, 2018
(86) PCT No.: PCT/US2018/012361

§ 371 Date: Jun. 19, 2019

Related U.S. Application Data
(60) Provisional application No. 62/443,178, filed on Jan. 6, 2017.

(51) Int. Cl. H01M 4/133; H01M 4/1393; H01M 4/38; H01M 4/36; H01M 4/62; H01G 11/26; H01G 11/36; H01G 11/86; H01G 11/38; H01G 11/46; C01B 32/05; C01B 32/194

(52) U.S. Cl. CPC H01M 4/133; H01M 4/1393; H01M 4/38; H01M 4/364; H01M 4/62; H01M 4/625; H01M 2004/021; H01G 11/36; H01G 11/86; H01G 11/38; H01G 11/46; C01B 32/05; C01B 32/194; H01G 11/26

(57) ABSTRACT

A porous carbon-based film, methods of making and uses thereof are described herein. The porous carbon-based film can include a porous carbon-based matrix including a plurality of yolk-shell type structures, and a plurality of graphene structures attached to the porous carbon-based matrix. Each yolk-shell type structure can include an elemental sulfur nanostructure positioned within a hollow space in the porous carbon-based matrix.

### CROSS REFERENCE TO RELATED APPLICATIONS

This application claims the benefit of priority of U.S. Provisional Patent Application No. 62/443,178 filed Jan. 6, 2017, which is hereby incorporated by reference in its entirety.

### BACKGROUND OF THE INVENTION

### A. Field of the Invention

The invention generally concerns a porous carbon-based film having a porous carbon-based matrix including a plurality of yolk-shell type structures. Each yolk-shell type structure can include an elemental sulfur nanostructure positioned within a hollow space in the porous carbon-based matrix. The films of the present invention can be used as electrodes in energy storage devices (e.g., secondary lithium-ion or lithium-sulfur batteries).

### B. Description of Related Art

The growing need for energy requires more environmentally friendly energy storage systems that are safe, low cost, and have high energy densities. Lithium-sulfur (Li—S) batteries have attracted much attention in recent years due to having a high theoretical capacity of 1672 mAh g⁻¹, which is over five times that of currently used transition metal oxide cathode materials. They also have a relatively low production cost, as sulfur is an abundant resource and is environmentally benign. Nonetheless, several challenges exist for Li—S batteries that hinder commercial application. Such challenges include the inherent low electrical conductivity of sulfur (5×10⁻³⁰ S cm⁻¹), which results in limited active material utilization efficiency and rate capability, and shuttling of high-order polysulfides between the cathode and anode. Further, polysulfide intermediates in the electrolyte are highly soluble, which can result in limited cycle stability. The high capacity and cycling ability of sulfur can arise from the electrochemical cleavage and re-formation of sulfur-sulfur bonds in the cathode, which, without wishing to be bound by theory, is believed to proceed in two steps. First, the reduction of sulfur to lithium higher polysulfides (Li₂Sₙ where 4≤n≤8) is followed by further reduction to lithium lower polysulfides (Li₂Sₙ where 1≤n≤3). The higher polysulfides can be dissolved into the organic liquid electrolyte, enabling them to penetrate through a polymer separator between the anode and cathode, and then react with the lithium metal anode, leading to the loss of sulfur active materials. Even if some of the dissolved polysulfides diffuse back to the cathode during the recharge process, the sulfur particles formed on the surface of the cathode are electrochemically inactive owing to their poor conductivity. Such a degradation path leads to poor capacity retention, especially during long cycling (e.g., more than 100 cycles). Furthermore, unlike lithium ion batteries (LIBs), where binders effectively hold the active materials without interrupting the electrochemical process, binders in Li—S batteries can play a critical role in the cell performance. As the structure and morphology change upon cycling, binders cannot hold all the active materials, especially the soluble polysulfides. Instead, they become “dead” sites for the electrochemical reactions, which can deteriorate the cell performance. Therefore, it is important to develop binder-free sulfur cathodes in order to facilitate green fabrication processes, allow high active material loading, increase electronic conductivity, and achieve excellent electrochemical performances.

Various attempts to improve Li—S batteries have been made. Bao et al., (“Facile synthesis of graphene oxide @ mesoporous carbon hybrid nanocomposites for lithium sulfur battery”, Electrochimica Acta, 2014, 127, pp. 342-348) and Chen et al., (“Sulfur-Infiltrated Graphene-Based Layered Porous Carbon Cathodes for High-Performance Lithium-Sulfur Batteries”, ACS Nano, 2014, 8(5), pp. 5208-5215), both describe graphene-based layered porous materials which can be used for encapsulating sulfur in cathodes for lithium/sulfur batteries to increase cycle discharge and capacity retention rate or offer improved conductivity, electrochemical performance, and cycle stability respectively. Other examples, such as Bakenov et al., (“Effect of graphene on sulfur/polyacrylonitrile nanocomposite cathode in high performance lithium/sulfur batteries”, Journal of the Electrochemical Society, 2013, 160(8), pp. 1194-1198) and Yin et al., (“Polyacrylonitrile/graphene composite as a precursor to a sulfur-based cathode material for high-rate rechargeable Li—S batteries”, Energy & Environmental Science, 2012, 5(5), pp. 6966-6972), both describe sulfur/PAN/graphene composite material as cathode material for Li—S batteries with improved properties.

Despite all of the currently available research on Li—S energy storage systems, many of these systems suffer from complex and non-environmentally friendly manufacturing protocols, low active material loading, and decrease electronic conductivity contributing to overall unsatisfactory electrochemical performances.

### SUMMARY OF THE INVENTION

A solution to the problems associated with Li—S energy storage systems has been discovered. The solution lies in a combination of materials that produce porous carbon-based films of the present invention useful for energy storage applications. In particular, the films contain a porous carbon-based matrix that includes sulfur yolk-shell nanostructures. These sulfur yolk-shell nanostructures can improve cyclability due to the presence of internal void spaces inside the carbon-based matrix, which allows for volume expansion of sulfur during lithiation (S/Li₂S, about 80% of volume increase). The matrix can also be doped with graphene (e.g., 0.1-5 wt. %) to increase electrical conductivity of the matrix. A pore-former (e.g., Li₂CO₃, polyvinylpyrrolidone (PVP), etc.) can be used to produce macropores throughout the carbon-based matrix, which can facilitate mass transfer, thereby shortening charge time. A plurality of polysulfide trapping agents (e.g., TiO₂, Al₂O₃, or both) can be embedded in the carbon-based matrix, in contact with the interior surface of void spaces present in the sulfur yolk-shell nanostructures, and/or in direct contact with the elemental sulfur nanostructures, or any combination thereof. The carbon-based matrix can be derived from carbon containing organic polymers that have been carbonized, thereby resulting in a mesoporous carbon matrix that includes at least 50 wt. %, 60 wt. %, 70 wt. %, 80 wt. %, or 90 wt. % carbon up to 100 wt. % carbon. In some embodiments, a nitrogen rich porous carbon-based matrix is produced from polyacrylonitrile. This combination of materials allows for expansion of the sulfur nanostructures and capture of any produced polysulfides, specifically, higher order polysulfides (Li₂Sₙ, where 4≤n≤8), while providing increased cyclability, thereby enhancing the electrochemical properties of Li—S energy storage systems. Furthermore, the films are made through an elegant cost effective and efficient process that allows the films to be tuned to meet the needs of the application (e.g., an energy device). The environmentally friendly porous carbon-based films are suitable for use in energy devices (e.g., lithium batteries, capacitors, supercapacitors and the like, preferably a lithium-sulfur secondary battery). In preferred instances, the films can be used as electrodes in such devices, preferably as cathodes.

In one particular embodiment, a porous carbon-based film is described. The porous carbon-based film includes a porous carbon-based matrix including: (a) a plurality of yolk-shell type structures, each yolk-shell type structure including an elemental sulfur nanostructure positioned within a hollow space in the matrix; and (b) a plurality of graphene structures attached to the porous carbon-based matrix. The porous carbon-based film can contain a matrix that includes mesopores and optionally macropores. In one aspect, the mesopores can have a diameter of 2 to 50 nm, preferably 2 to 10 nm and in another aspect, the optional macropores can have a diameter of 50 to 1000 nm, preferably 100 to 300 nm. One unique feature of the porous carbon-based film of the present invention is that the matrix can further include a polysulfide trapping agent embedded in the matrix, contained in the hollow space, or in direct contact with the elemental sulfur nanostructure, or any combination thereof. In some instances, the polysulfide trapping agent can be a metal oxide, non-limiting examples of which include MgO, Al₂O₃, CeO₂, La₂O₃, SnO₂, Ti₄O₇, TiO₂, MnO₂, or CaO, or any combination thereof. In other instances, the matrix can include nitrogen atoms or a nitrogen-containing compound. The hollow space found in the porous carbon-based matrix of the film can allow for volume expansion of the elemental sulfur nanostructure without deforming the matrix, preferably a volume expansion of at least 50%. In certain aspects, the film is binder-free. In other aspects, the elemental sulfur nanostructure can be derived from a metal sulfide, preferably from ZnS, CuS, MnS, FeS, CoS, NiS, PbS, Ag₂S, or CdS or any combination thereof. Without being limited to theory, the porous carbon-based matrix can be derived from any carbon-containing organic polymer. Non-limiting examples of the carbon-containing organic polymer are polyacrylonitrile (PAN), polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof. In a preferred instance, the porous carbon-based matrix is derived from polyacrylonitrile. The plurality of graphene structures attached to the porous carbon-based matrix can be embedded in or grafted to the porous carbon-based matrix. In some embodiments, the plurality of graphene structures is not necessary.

In another embodiment, an energy storage device including the porous carbon-based film is described. In one aspect, the energy storage device can be a rechargeable battery. In another aspect, the rechargeable (secondary) battery can be a lithium-ion or lithium-sulfur battery. In certain aspects of the invention, the porous carbon-based film can be used as an electrode film, preferably a cathode film, of the energy storage device. In other instances, the carbon-based film can be used as an anode film of the energy storage device.

Also described is a method of making the porous carbon-based film of the current invention. The method includes: (a) obtaining a composition comprising an organic solvent, a carbon-containing organic polymer, a plurality of optional graphene oxide structures, and a plurality of metal sulfide nanostructures; (b) forming a precursor film from the composition, the precursor film comprising a carbon-containing organic polymer matrix, the plurality of graphene oxide structures, and the plurality of metal sulfide nanostructures; (c) heat treating the precursor film to (i) convert the optional graphene oxide structures to graphene structures and (ii) form a porous carbon-based matrix from the carbon-containing organic polymer matrix; and (d) subjecting the heated-treated precursor film to conditions sufficient to oxidize the metal sulfide nanostructures to form elemental sulfur nanostructures comprised within hollow spaces of the porous carbon-based matrix, to obtain the porous carbon-based film of the current invention. In one aspect of the method, step (b) can include casting the composition, evaporating the organic solvent to form the precursor film, and drying the precursor film. Step (c) can include heating the precursor film to 300° C. to 1000° C. in an inert atmosphere for 2 to 12 hours. The carbon-containing organic polymer can be polyacrylonitrile, polydopamine, polyalkylene, polystyrene, polyacrylate, polyhalide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof. In a preferred instance, polyacrylonitrile is used. In another aspects, the plurality of metal sulfide nanostructures are ZnS, CuS, MnS, FeS, CoS, NiS, PbS, Ag₂S, or CdS, or any combination thereof, preferably ZnS. In other aspects, the composition in step (a) further includes a macropore-forming agent, a polysulfide trapping agent precursor, or mixtures thereof, and during the heat treating step (c), the macropore-forming agent can be removed from the precursor film and/or the polysulfide trapping agent precursor can be formed into a metal oxide containing polysulfide trapping agent. In certain instances, the macropore-forming agent can be a metal oxide, a metal salt, or a metal hydroxide selected from Li₂O, ZnO, Li₂CO₃, LiCl, LiNO₃, LiOH, K₂CO₃, or LiCO₃, or any combination thereof. In some embodiments, the macropore-forming agent is an organic polymer (e.g., PVP). In other instances, the polysulfide trapping agent precursor can be Mg(OH)₂, Al(OH)₃, Ce(OH)₃, La(OH)₃, Ti(OH)₄, or Ca(OH)₂ or any combination thereof, and the metal oxide containing polysulfide trapping agent can be MgO, Al₂O₃, CeO₂, La₂O₃, SnO₂, Ti₄O₇, TiO₂, MnO₂, or CaO, or any combination thereof.

In certain aspects of the present invention 20 embodiments are described. Embodiment 1 is a porous carbon-based film that includes a porous carbon-based matrix that includes: (a) a plurality of yolk-shell type structures, each yolk-shell type structure comprising an elemental sulfur nanostructure positioned within a hollow space of the porous carbon-based matrix; and (b) a plurality of graphene structures attached to the porous carbon-based matrix. Embodiment 2 is the porous carbon-based film of embodiment 1, wherein the porous carbon-based matrix comprises mesopores and optionally macropores. Embodiment 3 is the porous carbon-based film of embodiment 2, wherein the mesopores have a diameter of 2 to 50 nm, preferably 2 to 10 nm. Embodiment 4 is the porous carbon-based film of embodiment 2, wherein the macropores have a diameter of 50 to 1000 nm, preferably 100 to 300 nm. Embodiment 5 is the porous carbon-based film of any one of embodiments 1 to 4, wherein the matrix further comprises a polysulfide trapping agent embedded in the porous carbon-based matrix, contained in the hollow space, or in contact with the elemental sulfur nanostructure, or any combination thereof. Embodiment 6 is the porous carbon-based film of embodiment 5, wherein the polysulfide trapping agent is a metal oxide selected from MgO, Al₂O₃, CeO₂, La₂O₃, SnO₂, Ti₄O₇, TiO₂, MnO₂, or CaO, or any combination thereof. Embodiment 7 is the porous carbon-based film of any one of embodiments 1 to 6, wherein the hollow space allows for volume expansion of the elemental sulfur nanostructure without deforming the porous carbon-based matrix, preferably a volume expansion of at least 50%. Embodiment 8 is the porous carbon-based film of any one of embodiments 1 to 7, wherein the film is binder-free. Embodiment 9 is the porous carbon-based film of any one of embodiments 1 to 8, wherein the plurality of graphene structures are embedded in or grafted to the porous carbon-based matrix.

Embodiment 10 is an energy storage device comprising the porous carbon-based film of any one of embodiments 1 to 9. Embodiment 11 is the energy storage device of embodiment 10, wherein the energy storage device is a rechargeable battery, preferably a lithium-ion or a lithium-sulfur battery. Embodiment 12 is the energy storage device of any one of embodiments 10 to 11, wherein the porous carbon-based film is comprised in an electrode of the energy storage device.

Embodiment 13 is a method of making the porous carbon-based film of any one of embodiments 1 to 9, the method comprising: (a) obtaining a composition comprising an organic solvent, an organic polymer, a plurality of graphene oxide structures, and a plurality of metal sulfide nanostructures; (b) forming a precursor film from the composition, the precursor film comprising an organic polymer matrix, the plurality of graphene oxide structures, and the plurality of metal sulfide nanostructures; (c) heat treating the precursor film to (i) convert the graphene oxide structures to graphene structures and (ii) form a porous carbon-based matrix from the organic polymer matrix; and (d) subjecting the heated-treated precursor film to conditions sufficient to oxidize the metal sulfide nanostructures to form elemental sulfur nanostructures comprised within hollow spaces of the porous carbon-based matrix, wherein the porous carbon-based film of any one of embodiments 1 to 9 is obtained. Embodiment 14 is the method of embodiment 13, wherein: step (b) comprises casting the composition, evaporating the organic solvent to form the precursor film, and drying the precursor film; and step (c) comprises heating the precursor film to 300° C. to 1000° C. in an inert atmosphere for 2 to 12 hours. Embodiment 15 is the method of any one of embodiments 13 to 14, wherein the carbon-containing organic polymer is polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polyacrylonitrile. Embodiment 16 is the method of any one of embodiments 13 to 15, wherein the plurality of metal sulfide nanostructures are ZnS, CuS, MnS, FeS, CoS, NiS, PbS, Ag₂S, or CdS, or any combination thereof, preferably ZnS. Embodiment 17 is the method of any one of embodiments 13 to 16, wherein the composition in step (a) further comprises a macropore-forming agent, a polysulfide trapping agent precursor, or both. Embodiment 18 is the method of embodiment 17, wherein, during heat treating step (c), the macropore-forming agent is removed from the precursor film and/or the polysulfide trapping agent precursor is formed into a polysulfide trapping agent. Embodiment 19 is the method of any one of embodiments 17 to 18, wherein the macropore-forming agent is a metal oxide, a metal salt, or a metal hydroxide selected from Li₂O, ZnO, Li₂CO₃, LiCl, LiNO₃, LiOH, K₂CO₃, or LiCO₃, or any combination thereof and/or the polysulfide trapping agent precursor is Mg(OH)₂, Al(OH)₃, Ce(OH)₃, La(OH)₃, Ti(OH)₄, or Ca(OH)₂ or any combination thereof. Embodiment 20 is the method of any one of embodiments 17 to 19, wherein the metal oxide containing polysulfide trapping agent is MgO, Al₂O₃, CeO₂, La₂O₃, SnO₂, Ti₄O₇, TiO₂, MnO₂, or CaO, or any combination thereof.

Other embodiments of the invention are discussed throughout this application. Any embodiment discussed with respect to one aspect of the invention can apply to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, porous carbon-based films of the invention can be used to achieve methods of the invention.

The following includes definitions of various terms and phrases used throughout this specification.

“Graphene materials” include single-layer graphene, two-layers graphene, multi-layers graphene, graphene oxide, reduced graphene oxide, or modified graphene, or any combination thereof.

“Graphene composite” or “Graphene composite material” refers to a material that includes graphene and another material. By way of example, a carbon-based material-graphene composite of the present invention includes graphene or graphene oxide and a carbon-based material. The carbon-based material is not graphene or graphene oxide. Non-limiting examples of carbon material-graphene composites of the present invention are illustrated in FIGS. 1A, 1B, 2A, 2B, 3A, 3B, and 4.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof “Nanoparticles” include particles having an average diameter size of 1 to 1000 nanometers.

“Microstructure” refers to an object or material in which at least one dimension of the object or material is greater than 1000 nm (e.g., greater than 1000 nm up to 5000 nm) and in which no dimension of the structure is 1000 nm or smaller. The shape of the microstructure can be of a wire, a particle (e.g., a substantially spherical-shaped particle), a rod, a tetrapod, a hyper-branched structure, a tube, a cube, or mixtures thereof “Microparticles” include particles having an average diameter size of greater than 1000 nm, preferably greater than 1000 nm to 5000 nm, or more preferably greater than 1000 nm to 10000 nm.

A “yolk/shell structure” includes instances where less than 50% of the surface of the “yolk” contacts the shell. In the context of the present invention, a void space is present in the yolk/shell like structure that has a volume sufficient to allow for volume expansion of the yolk. The yolk can be a nano- or microstructure, preferably a sulfur nanostructured yolk. By way of example, the yolk can be a sulfur nanostructured yolk, and the shell can be a void space present within the carbon-based matrix. Therefore, the carbon-based matrix can act as a shell for the yolk/shell structure. In preferred instances, the carbon-based matrix of the present invention includes a plurality of yolk/shell structures, where the carbon-based matrix acts as the shell for the plurality of yolk/shell structures.

A “core/shell structure” phrase includes instances where 50% or more of the surface of the “core” contacts the shell. A void space can be present in the core/shell structure.

Determination of whether a core/shell or yolk/shell is present can be made by persons of ordinary skill in the art. One example is visual inspection of a transition electron microscope (TEM) or a scanning transmission electron microscope (STEM) image of a porous carbon-based film of the present invention and determining whether at least 50% (core) or less (yolk) of the surface of a given nanostructure (preferably a nanoparticle) contacts the carbon-based matrix of the film.

The phrase “higher metal polysulfides” refers to metal sulfides having a formula of MₓSₙ where 4≤n≤8, M is a metal, and x+n balance the valence requirements of the compound. A non-limiting example of a higher metal polysulfide is Li₂Sₙ where 4≤n≤8.

The phrase “lower polysulfides” refers to metal sulfides having a formula of MₓSₙ where 1≤n≤3, M is a metal, and x+n balance the valence requirements of the compound. A non-limiting example of a lower metal polysulfide is Li₂Sₙ where 1≤n≤3.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The use of the words “a” or “an” when used in conjunction with any of the terms “comprising,” “including,” “containing,” or “having” in the claims or the specification may mean “one,” but it is also consistent with the meaning of “one or more,” “at least one,” and “one or more than one.”

The terms “inhibiting” or “reducing” or “preventing” or “avoiding” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The porous carbon-based films of the present invention can “comprise,” “consist essentially of” or “consist of” particular ingredients, components, compositions, etc. disclosed throughout the specification. With respect to the transitional phase “consisting essentially of,” in one non-limiting aspect, a basic and novel characteristic of the porous carbon-based films of the present invention are their high flux for mass transfer ability, high electric conductivity, and increased cyclability due to formed sulfur/carbon yolk-shell structures, and metal oxides, as polysulfide trapping agents, present in the films.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1A is a cross-sectional view of porous carbon-based film of the present invention that includes a single yolk-shell structure.

FIG. 1B is a cross-sectional view of a porous carbon-based film of the present invention that includes multiple yolk-shell structures.

FIG. 2A is a cross-sectional view of a porous carbon-based film of the present invention that includes a yolk-shell structure and macropores.

FIG. 2B is a cross-sectional view of a porous carbon-based film of the present invention that includes multiple yolk-shell structures and macropores.

FIG. 3A is a cross-sectional view of a porous carbon-based film of the present invention that includes multiple yolk-shell structures, macropores, and polysulfide trapping agents.

FIG. 3B is a cross-sectional view of a porous carbon-based film of the present invention that includes multiple yolk-shell structures, macropores, and polysulfide trapping agents present in the porous carbon-based matrix.

FIG. 4 is a cross-sectional view of a porous carbon-based film of the present invention that includes multiple yolk-shell structures, macropores, and polysulfide trapping agents present in the porous carbon matrix and in the yolk-shell structures.

FIG. 5 is a schematic of a method to produce a porous carbon-based film of the present invention that includes multiple yolk-shell structures.

FIG. 6 is a schematic of a method to produce a porous carbon-based film of the present invention that includes multiple yolk-shell structures and macropores.

FIG. 7 is a schematic of a method to produce a porous carbon-based film of the present invention that includes multiple yolk-shell structures, macropores, graphene structures, and polysulfide trapping agents.

FIG. 8 is a schematic of a method to produce a porous carbon-based film of the present invention that includes multiple yolk-shell structures, macropores, and polysulfide trapping agents.

FIG. 9A is a scanning electron microscopy (SEM) image of TiO₂ nanoparticles polysulfide trapping agents.

FIG. 9B is a SEM image of a ZnS particle used as a sulfur precursor.

FIG. 9C is an optical image of a ZnS@TiO₂@PAN film of the present invention.

FIG. 9D is the SEM image of a cross-section of the ZnS@TiO₂@PAN film.

FIG. 9E is the magnified SEM image of ZnS@TiO₂@PAN film of FIG. 9D.

FIG. 9F is the Energy dispersive X-ray (EDX) data for the ZnS@TiO₂@PAN film of the present invention.

FIG. 10 are the X-ray diffraction (XRD) patterns of ZnS particles, TiO₂ particles, and the ZnS@TiO₂@PAN film of the present invention.

FIG. 11A is a top view SEM image of the ZnS@TiO₂@C film of the present invention.

FIGS. 11B and 11C are the SEM cross-sectional and magnified cross-sectional views of the ZnS@TiO₂@C of the present invention.

FIG. 11D is the EDX of the ZnS@TiO₂@C film of the present invention.

FIGS. 12A and 12B are the SEM cross-sectional and magnified cross-sectional views of the S@TiO₂@C film of the present image.

FIG. 12C is EDX spectra of the S@TiO₂@C film of the present invention.

FIG. 12D is the thermogravimetric (TGA) scan of the S@TiO₂@C film of the present invention.

FIG. 13 are the XRD patterns of the S@TiO₂@C film of the present invention, sulfur, TiO₂, ZnS@TiO₂@C film of the present invention and ZnS@TiO₂@PAN film of the present invention.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

A solution that overcomes the problems associated with lithium-sulfur-based energy storage systems has been discovered. The solution is premised on a porous carbon-based composite film having high flux for mass transfer, high electric conductivity, and increased cyclability. The film can be used in energy devices, for example, lithium-sulfur-based energy storage devices. The carbon-based composite films are binder-free. An advantage of having a binder-free film is that as the structure and morphology of an electrode (e.g., cathode electrode) changes upon cycling, binders cannot hold all the active materials, especially soluble polysulfides. Instead, they could become “dead” sites for the electrochemical reactions that can deteriorate the cell performance. The porous carbon-based matrix of the films of the present invention include a plurality of elemental sulfur/carbon yolk-shell structures and a plurality of graphene structures attached to the porous carbon-based matrix. The sulfur/carbon yolk-shell structures include sulfur nanostructures and shells that are void spaces present in the matrix, with the sulfur nanostructures present within the void spaces. In some embodiments, polysulfide trapping agents are also present throughout the carbon-based matrix or the void spaces present in the matrix. The films of the present invention can be produced in a manner that allows for tunability of the yolks, shells, and/or polysulfide trapping agents to meet the needs of energy storage devices. Even further, advantages can be realized when the carbon-based matrix includes nitrogen species. For example, a nitrogen enriched carbon-based matrix can (1) enhance the electrochemical properties of the films, (2) provide high adsorption of sulfur, and/or (3) provide good mechanical strength to the films.

These and other non-limiting aspects of the present invention are discussed in further detail in the following sections with reference to the figures.

### A. Porous Carbon-Based Films

The porous carbon-based films of the present invention include a porous carbon-based matrix that has a plurality of sulfur yolk-shell structures. The yolks can be elemental sulfur nanostructures, and the shell can be void spaces present within the matrix such that the matrix acts as the shell for the yolk-shell structures.

1. Porous Carbon-Based Matrix Having a Single or a Plurality of Sulfur Yolk/Shell Structures

The porous carbon-based matrix can be derived from carbon containing organic polymers that have been heat-treated, thereby resulting in a porous carbon-based matrix that includes at least 50 wt. %, 60 wt. %, 70 wt. %, 80 wt. %, or 90 wt. % carbon up to 100 wt. % carbon. The elemental sulfur yolk/shell structure includes at least one (single yolk-shell containing matrix), preferably a plurality of (multi yolk-shell containing matrix), elemental sulfur nanostructure(s) contained within a discrete void space (single yolk-shell containing matrix) or multiple discrete void spaces (multi yolk-shell containing matrix) present in the porous carbon-based matrix. In this sense, the porous carbon-based matrix, which can be in the shape of a film (e.g., planar or flattened film), serves to create the shell for the yolk-shell structure(s).

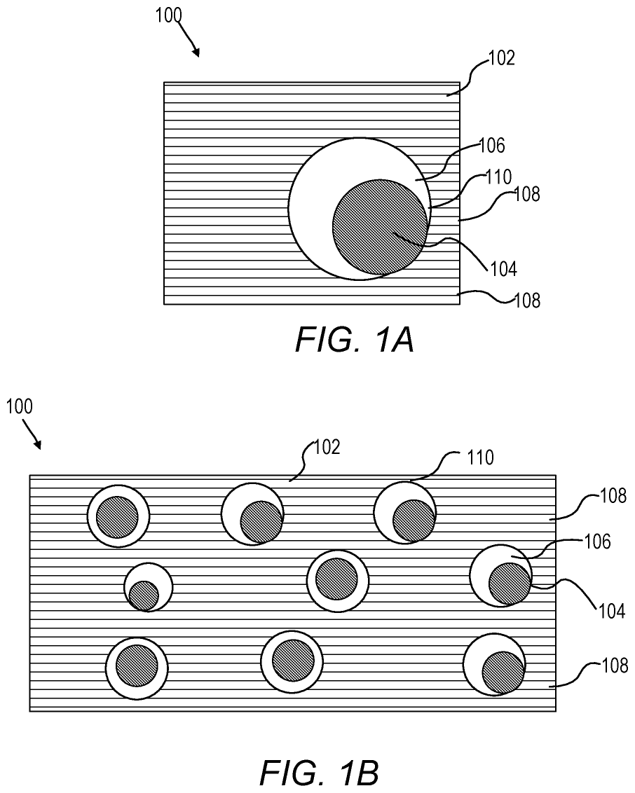

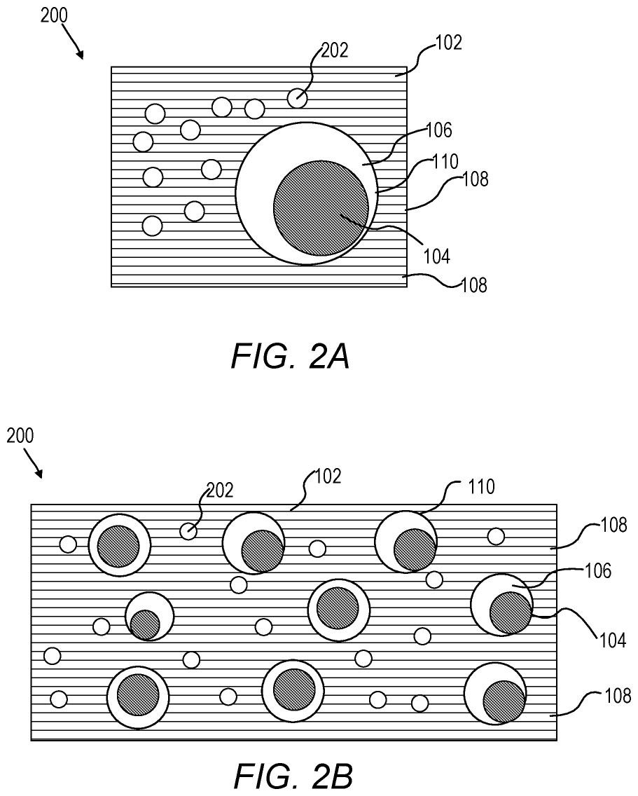

FIGS. 1A, 1B, 2A, and 2B are cross-sectional illustrations of porous carbon-based films 100 having a yolk/porous carbon-containing shell structure. FIGS. 1A and 1B show a single yolk-shell structure and a multi-yolk-shell structure without micropores, respectively. FIGS. 2A and 2B show a single yolk-shell structure and a multi-yolk-shell structure with micropores, respectively. Porous films 100 and 200 include a porous carbon-based matrix 102. FIGS. 1A and 1B show porous carbon-based matrix 102 that includes elemental sulfur yolk 104, void space 106 (hollow space), and graphene structures 108. As discussed in detail below, void space 106 having the elemental sulfur nanostructure 104 can be formed by oxidation of a sulfur nanostructure precursor material. FIGS. 2A and 2B show carbon-based matrix 102 that includes elemental sulfur yolk 104, void space 106 (hollow space), graphene structures 108, and macropores 202. The carbon-based matrix in all of the figures include mesopores (not shown). Graphene structures 108 are shown as continuous structures, however, the structures can be discontinuous or overlapping graphene material. Graphene structures 108 and carbon-based matrix 102 can form a composite type material or composite film. Notably, the carbon-based materials (film) 100 and 200 are binder free. The thickness of the film can range from 100 to 1000 μm, or about 200 nm, 250 nm, 300 nm, 350 nm, 400 nm, 450 nm, 500 nm, 550 nm, 600 nm, 700 nm, 750 nm, 800 nm, 900 nm, 1000 nm, to 1000 μm or any range or value there between. Macropores 202 can have an average pore size of 50 to 1000 nm, 75 to 500 nm, or preferably 100 to 300 nm, or about 50 nm, 55 nm, 60 nm, 65 nm, 70 nm, 75 nm, 80 nm, 85 nm, 90 nm, 95 nm, 100 nm, 110 nm, 120 nm, 130 nm, 140 nm 150 nm, 160 nm, 170 nm, 180 nm, 190 nm, 200 nm, 210 nm, 220 nm, 230 nm, 240 nm, 250 nm, 260 nm, 270 nm, 280 nm, 290 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm or any range or value there between. Without wishing to be bound by theory, it is believed that macropores can enhance mass transfer of ions in and out of the carbon-based matrix, which can shorten the time required to charge an energy device. Mesopores present in the carbon-based matrix 102 can have an average size of 2 to 50 nm, 3 to 40 nm, 4 to 30 nm, 5 to 20 nm, 6 to 10 nm, preferably 2 to 10 nm, or about 2 nm, 3 nm, 4 nm, 5 nm, 6 nm, 7 nm, 8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm or any range or value there between.

Referring to FIGS. 1A, 1B, 2A, and 2B, wall or interior surface 110 defining void space 106 can be a portion of carbon-based matrix 102. Elemental sulfur yolk 104 can contact or may not contact the carbon-based matrix 102. By way of example, FIG. 1A and FIG. 2A illustrate instances where sulfur yolk 104 does not contact matrix 102. FIGS. 1B and 2B illustrate instances where sulfur yolks 104 contact matrix 102 in some instances and do not contact matrix 102 in other instances. Again, carbon-based matrix 102 acts as a shell for the yolk-shell structure(s). In certain aspects, 0% to 49%, 30% to 40%, or 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 36%, 37%, 38%, 39%, 40%, 41%, 42%, 43%, 44%, 45%, 46%, 47%, 48%, 49% or any range or value there between, of the surface of elemental sulfur yolk 104 contacts shell 102. In instances where yolk 104 is a particle, the diameter of the yolk 104 can range from 1 nm to 1000 nm, preferably 1 nm to 50 nm, or more preferably 1 nm to 5 nm or any value or range there between.

2. Porous Carbon-Based Matrix Having a Plurality of Yolk/Shell Structures and Polysulfide Trapping Agents

The porous carbon-based matrix can include polysulfide trapping agents. A plurality of such trapping agents can be embedded in the carbon-containing porous matrix, in contact with the interior surface of the hollow space, comprised in the hollow space, in contact with the elemental sulfur nanostructure, or any combination thereof. The polysulfide trapping agent can be a nanostructure having a high surface area and good surface diffusion properties. Without wishing to be bound by theory, it is believed that the polysulfide trapping agent can bind polysulfides through chemisorption. By way of example, a metal polysulfide (e.g., Li₂Sₙ) can undergo a chemical reaction with the polysulfide trapping agent to bind the metal polysulfide to the surface of the polysulfide trapping agent (chemisorption). This binding can suppress the shuttle effect and enable full utilization of the active material (e.g., lithium ions and elemental sulfur). Since the polysulfide trapping agent is distributed in the hollow portions of the matrix (e.g., direct contact with the yolk, present in the void space, but not contacting the yolk, or in direct contact with the interior surface of the void space), or embedded in the carbon matrix, the balance between polysulfide adsorption and surface diffusion can be tuned to allow the sulfide species to deposit on the surface of the polysulfide trapping agent. This can enhance the cycling performance of the lithiation process.

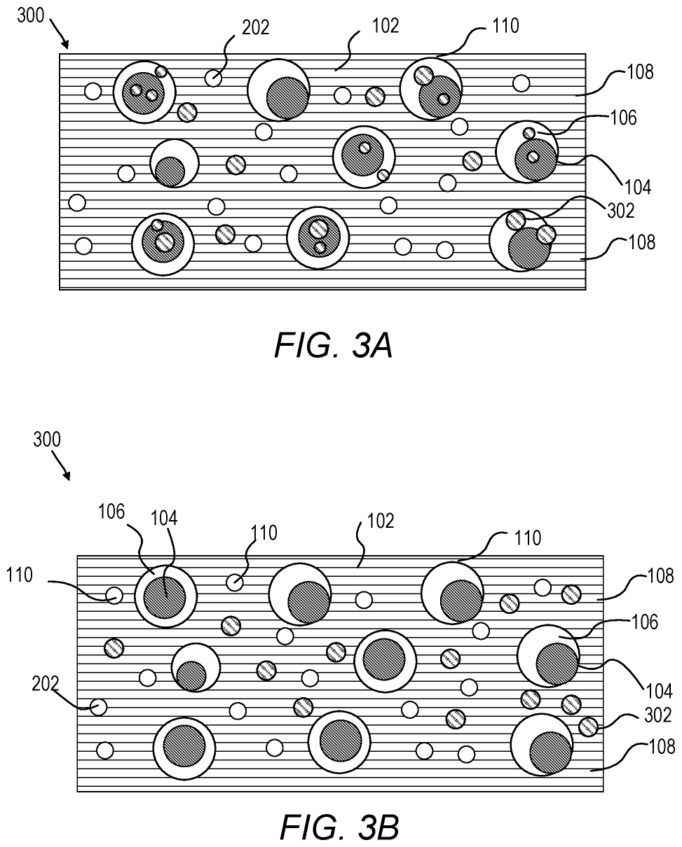

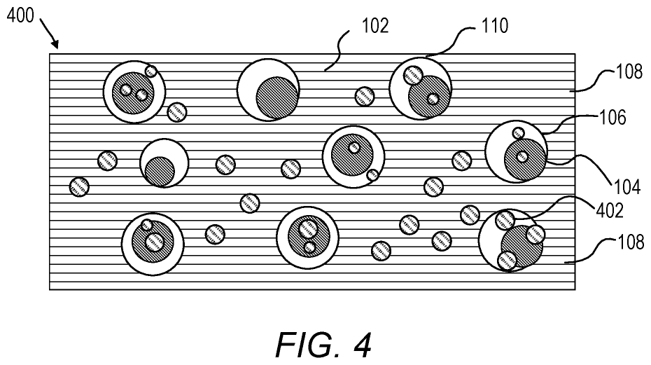

FIGS. 3A and 3B depict cross-sectional illustrations of porous carbon-based films 300 having a carbon based matrix 102 with a plurality of elemental sulfur yolk/shell structures, a plurality of polysulfide trapping agents 302, and a plurality of macropores 202. FIG. 3A depicts film 300 having polysulfide agents 302 embedded in carbon-containing porous matrix 102 in contact with interior surface 110 of void space 106, comprised in void space 106, and in direct contact with elemental sulfur nanostructure yolks 104. FIG. 3B depicts polysulfide trapping agents 302 embedded in carbon-containing porous matrix 102. FIG. 4 depicts film 400 having polysulfide trapping agents 302 embedded in carbon-containing porous matrix 102 without mesopores 202. Other embodiments can include polysulfide agents 302 positioned only in void space 106 and/or polysulfide agents 302 only in contact with elemental sulfur yolk 104 (i.e., not embedded in the carbon-containing matrix). Compounds suitable for polysulfide trapping agents are discussed in more detail below.

### B. Materials

The materials or material precursors used to form the films of the present invention can be obtained from commercial sources, produced as described throughout the specification, or a combination of both.

1. Carbon-Based Matrix Precursors

The carbon-based matrix can be obtained from an organic precursor compound that has been subjected to condition suitable to convert the organic compound into a porous carbon-based matrix. The carbon-based matrix of the present invention has mesopores present throughout the matrix. The mesopores are formed by carbonizing a carbon containing organic polymer. Non-limiting examples of carbon containing organic polymers, which can optionally include other atoms such as nitrogen atoms, include polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof. In a preferred embodiment, polyacrylonitrile is converted to the porous carbon-containing matrix, which can be beneficial in that it produces a carbon-based matrix having nitrogen present throughout the matrix. The resulting carbon-based matrix can include at least 50 wt. %, 60 wt. %, 70 wt. %, 80 wt. %, or 90 wt. % carbon up to 100 wt. % carbon.

2. Graphene Materials

Graphene or graphene oxide material can be grafted graphene oxide or graphene oxide. Graphene oxide can be obtained from various commercial sources or prepared as exemplified in the Example section by modification of known literature methods (e.g., Hummers et al., J. Am. Chem. Soc., 1958, 80, 1339-1339, which is incorporated by reference). The graphene oxide can have a lamellar thickness of 3-5 layers (3, 4, or 5 layers) and a specific surface area of 600-800 m²/g or 650 to 750 m²/g, or about 600 m²/g, 625 m²/g, 650 m²/g, 675 m²/g, 700 m²/g, 725 m²/g, 750 m²/g, 775 m²/g, or 800 m²/g, Grafting agents and solvents can be obtained from various commercial sources such as Sigma-Aldrich® (U.S.A.). Graphene can be formed from reduction of graphene oxide, made in-house and/or purchased from various commercial sources such as Nanjing JCNANO, Inc (CHINA).

3. Elemental Sulfur and Elemental Sulfur Precursors

Yolk 104 includes elemental sulfur. Elemental sulfur can include, but is not limited to, all allotropes of sulfur (i.e., Sₙ where n=1 to ∞). Non-limiting examples of sulfur allotropes include S, S₂, S₄, S₆, and S₈, with the most common allotrope being S₈. The elemental sulfur precursor can be any material capable of being converted to elemental sulfur. In a preferred embodiment, the elemental sulfur precursor can be a metal sulfide. The metal of the metal sulfide can be a transition metal of the Periodic Table. Non-limiting examples of transition metals include iron (Fe), silver (Ag), copper (Cu), nickel (Ni), zinc (Zn), manganese (Mn), cobalt (Co), lead (Pb), or cadmium (Sn). Non-limiting examples of metal sulfides include ZnS, CuS, MnS, FeS, CoS, NiS, PbS, Ag₂S, or CdS, or any combination thereof. In a preferred embodiment, ZnS is used as the elemental sulfur precursor material. In some embodiments, the metal sulfide (e.g., ZnS) can be prepared from a metal precursor material (e.g., zinc acetate) and a sulfur source (e.g., thiourea). The metal precursor material and the sulfur source can be dissolved in a solvent (e.g., aqueous solution) and a templating agent (e.g., a surfactant such as gum Arabic) under agitation (e.g., sonification) sufficient to dissolve all the reagents A molar ratio of the metal precursor material to the sulfur source can range from 0.4:1 to 1:1, or about 0.5:1. The resulting solution can be heated under hydrothermal conditions (e.g., autogenous) at 110° C. to 140° C., or 115° C. to 130° C., or 120° C. to 125° C., or about 120° C. for at time sufficient to react the metal precursor with the sulfur source to produce metal sulfide nanoparticles (e.g., 10 to 20, or about 15 hours). The resulting metal sulfide nanoparticles can be isolated using known isolation methods (e.g., centrifugation, filtration, and the like), washed with solvent to remove any unreacted reagents, and dried under vacuum (e.g., 60° C. to 80° C. or about 70° C. for about 1 to 5, or about 3 hours). In some embodiments, the polysulfide trapping agent precursor material, polysulfide trapping agent, or mixture thereof, can be added to the solution having the metal source and sulfur source to form a metal sulfide material having polysulfide trapping agent and/or polysulfide trapping agent precursor material dispersed throughout after heating under autogenous pressure.

4. Polysulfide Trapping Agents and Polysulfide Trapping Agent Precursor Materials

The polysulfide trapping agents can be metal oxides. The metal portion of the metal oxide can be an alkali metal (Column 1 of the Periodic Table), alkaline earth metal (Column 2 of the Periodic Table), a transition metal (Columns 3-12 of the Periodic Table), a post transition metal (metal of Columns 13-15 of the Periodic Table), or a lanthanide metal. Non-limiting examples of metals include magnesium (Mg), aluminum (Al), cerium (Ce), lanthanum (La), tin (Sn), titanium (Ti), Mn, calcium (Ca), or any combination thereof. Non-limiting examples of metal oxides suitable for use in the present invention include MgO, Al₂O₃, CeO₂, La₂O₃, SₙO₂, Ti₄O₇, TiO₂, MnO₂, or CaO, or any combination thereof. In a preferred embodiment, Al₂O₃ is used. The metal oxide can be obtained from metal oxide precursor compounds. For example, the precursor material can be obtained as a metal hydroxide, a metal nitrate, a metal amine, a metal chloride, a metal coordination complex, a metal sulfate, a metal phosphate hydrate, metal complex, or any combination thereof. In some embodiments, the polysulfide trapping agent can be prepared by dissolving a polysulfide trapping agent precursor (e.g., Al(NO₃)₃.9H₂O) in a solvent (e.g., water) and adding a basic precipitation agent (e.g., ethylenediamine) to adjust the pH to 7 to 9, or about 8, to precipitate polysulfide trapping agent precursor (e.g., Al(OH)₃) from the solution. The polysulfide trapping agent precursor can be dried under vacuum, and then calcined at 850 to 1000° C., or about 850° C., 900° C., 950° C., or 1000° C. to convert the polysulfide trapping agent precursor material to a polysulfide trapping agent (e.g., Al(OH)₃ to Al₂O₃).

5. Macropore-Forming Agents

The macropore-forming agents can be metal oxides, metal carbonates, metal halides, metal nitrates, or metal hydroxides, or carbon-based materials. The metal portion of the macropore-forming agent can be an alkali metal (Column 1 of the Periodic Table), alkaline earth metal (Column 2 of the Periodic Table), and/or a transition metal (Columns 3-12 of the Periodic Table). Non-limiting examples of metals include magnesium (Mg), zinc (Zn), and potassium (K), or any combination thereof. Non-limiting examples of macropore-forming agents suitable for use in the present invention include Li₂O, ZnO, Li₂CO₃, LiCl, LiNO₃, LiOH, K₂CO₃, LiCO₃, PVP, or any combination thereof. Macropore-forming agents can be obtained from commercial sources such as, for example, Sigma-Aldrich®.

### C. Preparation of the Films of the Present Invention

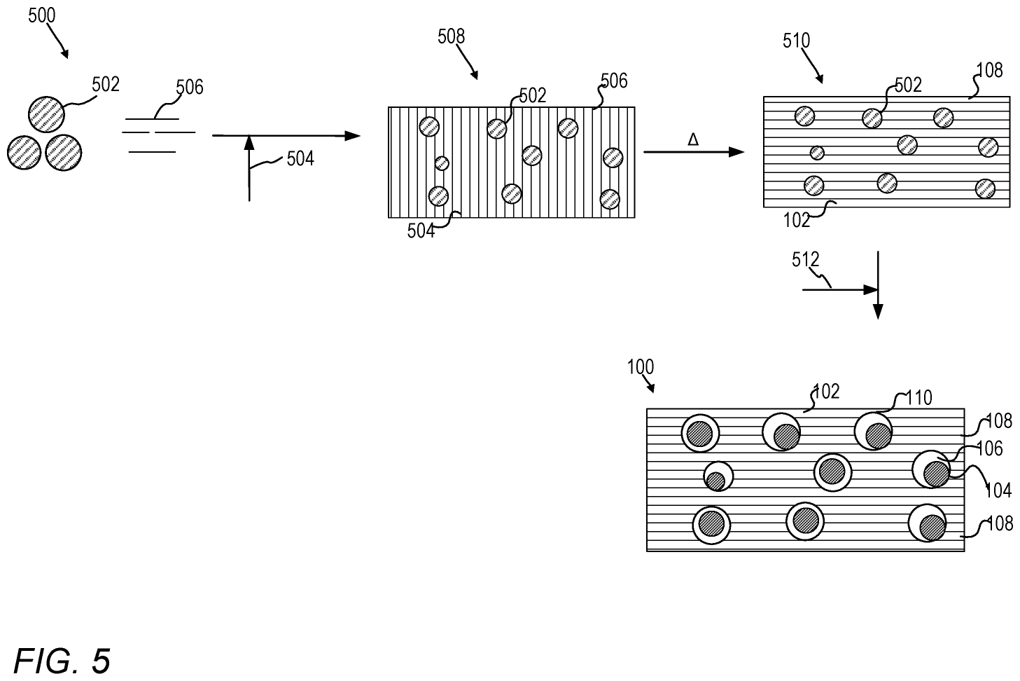

The films of the present invention can be made using methods described herein and methods exemplified in the Examples section. FIG. 5 depicts a method to produce a porous carbon-based film of the present invention with the porous carbon-based matrix of the film having a plurality of graphene structures attached to the porous carbon-based matrix and a plurality of elemental sulfur structures encompassed in hollow spaces of the carbon-based matrix. In method 500, elemental sulfur precursor materials 502 (e.g., ZnS), graphene material 506 (e.g., graphene oxide), and carbon-containing organic polymer 504 can be obtained as described in the Materials Section and dispersed with in a polar solvent (e.g., dimethylformamide). The resulting dispersion can be subjected to conditions to produce film 508. For example, a casting process can be used. In a casting process the dispersion can be cast or poured or coated onto a carrier substrate or mold (e.g., a glass ring), and the solvent can be removed (e.g., evaporated) to create a solid layer (e.g., film) on the carrier substrate. The carrier substrate can be removed to produce a standalone film 508 containing graphene material 506 and having elemental sulfur precursor material 502 embedded in carbon-containing organic polymer matrix 504. The resulting mixed matrix film 508 can be subjected to conditions sufficient to carbonize organic polymer 504 to form porous carbon-based matrix 102 and convert graphene material 506 to graphene structures 108, attach the graphene structures to the porous carbon-material and form carbon-based film 510. Porous carbon-based film 510 can include porous carbon-based matrix 102 having graphene structures 108 attached to the matrix and elemental sulfur precursor materials 502 embedded in the porous carbon-based matrix 102. For example, film 508 can be heat-treated to 250° C. to 350° C., or 300° C. at a rate 1 to 5 or 2° C. per min under air and kept for a period of time (e.g., 1 to 5 h or 2 h) for pre-oxidation. The atmosphere can be changed to an inert atmosphere (e.g., argon), and the film can be heated at a temperature of at least, equal to, or between any two of 300° C. and 800° C. at rate of 1 to 10 or 5° C./min and kept until the porous carbon-based matrix is formed (e.g., 3 to 10 h, or 4 h) and the graphene structures are attached to the porous carbon-based matrix.

Porous carbon-based film 510 can be contacted with an oxidizing solution 512 (e.g., an iron (III) solution such as ferric nitrate) to convert elemental sulfur precursor materials 502 to elemental sulfur yolks 104 and form void spaces 106 in the porous carbon-based matrix 102, forming multiple yolk-shell structures in the porous carbon-based matrix. Reduction of the metal sulfide to elemental sulfide produces a smaller compound thereby forming void spaces 106 in the carbon-containing matrix. In this sense, the matrix becomes the shells for the yolk/shell structures. By way of example, porous carbon-based film 510 can be mixed with an aqueous ferric nitrate solution. The resulting suspension can be agitated with cooling for a time sufficient to allow the iron to react with the zinc sulfide as follows:

2Fe³⁺_{(aq)}+ZnS₍ₛ₎ [symbol] 2Fe²⁺_{(aq)}+Z²⁺_{(aq)}+S_{(S)}

Mineral acid (e.g., hydrochloric acid) can be added to the film to remove any remaining zinc sulfide. The porous carbon-based film can be washed several times in deionized water, and can be dried at a temperature of at least, equal to, or between any two of 60° C. and 80° C. or about 70° C. until dry (e.g., about 2 to 10 hours, or 3 to 5 hours). The resulting porous carbon-based film 100 can include elemental sulfur yolks 104 inside void spaces 106 of porous carbon-based matrix 102. Graphene structures are attached to the porous carbon-based matrix. In some embodiments, the plurality of graphene structures can be embedded in or grafted to the porous carbon-based matrix. In some embodiments, the graphene structures are not present. The combination of carbon-based matrix 102, optional graphene structures 108, and elemental sulfur yolk-shell structures can be referred to as a mixed matrix composite.

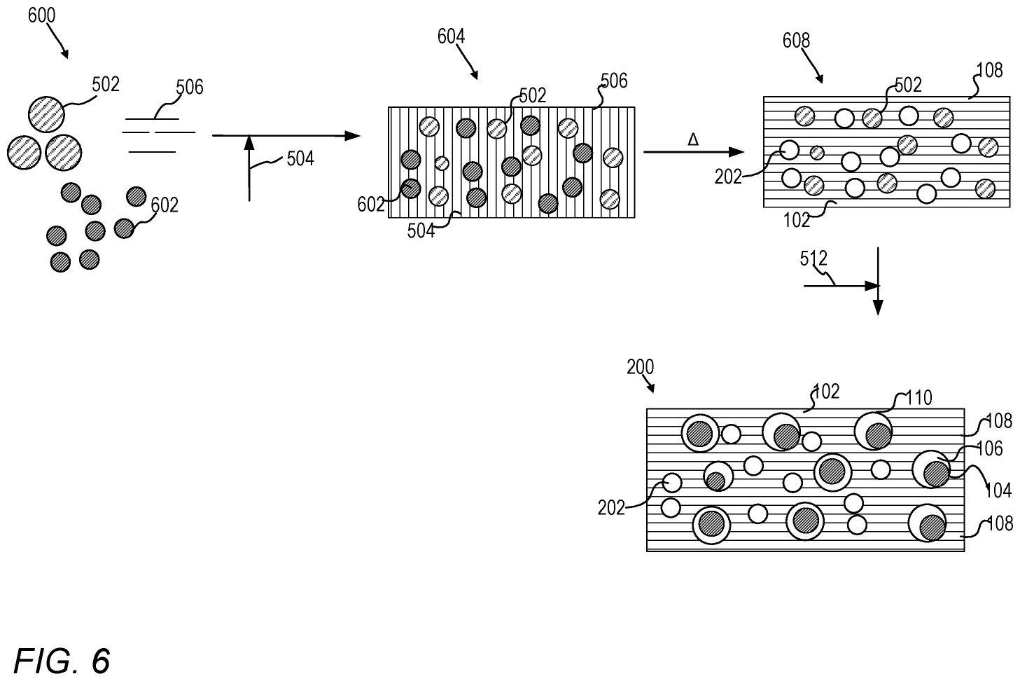

FIG. 6 depicts a method to produce a porous carbon-based film of the present invention with the porous carbon-based matrix containing macropores and having a plurality of graphene structures attached to the porous carbon-based matrix and a plurality of elemental sulfur structures encompassed in a hollow space of the carbon-based matrix. In method 600, elemental sulfur precursor materials 502 (e.g., ZnS), graphene material 506 (e.g., graphene oxide), organic polymer 504, and macropore-forming materials (agents) 602 (e.g., LiCO₃ or PVP) can be obtained as described in the Materials Section and dispersed in a polar solvent (e.g., dimethylformamide). The resulting dispersion can be subjected to conditions to produce a film. For example, a casting process can be used. In a casting process, the dispersion can be cast or poured or coated onto a carrier substrate or mold (e.g., a glass ring) and the solvent can be removed (e.g., evaporated) to create a solid layer (e.g., film) on the carrier substrate. The carrier substrate can be removed to produce a standalone film 604 containing graphene materials 506 and having elemental sulfur precursor materials 502 and macropore-forming materials 602 embedded in organic polymer matrix 504. The resulting mixed matrix film 604 can be subjected to conditions sufficient to carbonize organic polymer 504 to form porous carbon-based matrix 102, convert graphene materials 506 to graphene structures 108 and attach the graphene structures to the matrix, and form macropores 202 from macropore-forming material 602, thereby forming porous carbon-based film 608. Porous carbon-based film 608 can include porous macroporous carbon-based matrix 102 having graphene structures 108 attached to the matrix and elemental sulfur precursor materials 502 embedded in the porous carbon-based matrix. For example, the mixed matrix film 604 can be heat-treated to 250° C. to 350° C., or about 300° C. at a rate 1 to 5 or 2° C. per min under air and kept for a period of time (e.g., 1 to 5 h or 2 h) for pre-oxidation. The atmosphere can be changed to an inert atmosphere (e.g., argon), and the film can be heated from 300° C. to 800° C. at rate of 1 to 10 or 5° C./min and kept until the porous carbon-based matrix is formed (e.g., 3 to 10 h, or 4 h), macropores are formed, and the graphene material is converted to graphene structures and attached to the porous carbon-based matrix.

Porous carbon-based film 608 can be contacted with a sulfur oxidizing solution 512 (e.g., an iron (III) solution such as ferric nitrate) to convert elemental sulfur precursor materials 502 to elemental sulfur yolks 104 and form void spaces 106 in the porous carbon-based matrix 102, thereby forming multiple yolk-shell structures in the porous carbon-based matrix. Reduction of the metal sulfide to elemental sulfide produces a smaller compound thereby forming void space 106 in the carbon-containing matrix. By way of example, Porous carbon-based film 608 can be mixed with an aqueous ferric nitrate solution. The resulting suspension can be agitated with cooling for a time sufficient to allow the iron to react with the zinc sulfide as described above. Mineral acid (e.g., hydrochloric acid) can be added to the film to remove any remaining zinc sulfide. The porous carbon-based film can be washed several times in deionized water, and then was dried at 60 to 80 or about 70° C. until dry (about 2 to 10 hours, or 3 to 5 hours). The resulting porous carbon-based film 200 can include elemental sulfur yolks 104 comprised in void spaces 106 of porous carbon-based matrix 102 containing macropores 202 and having graphene structures 108 attached to the porous carbon-based matrix. In some embodiments, the plurality of graphene structures can be embedded in or grafted to the porous carbon-based matrix.

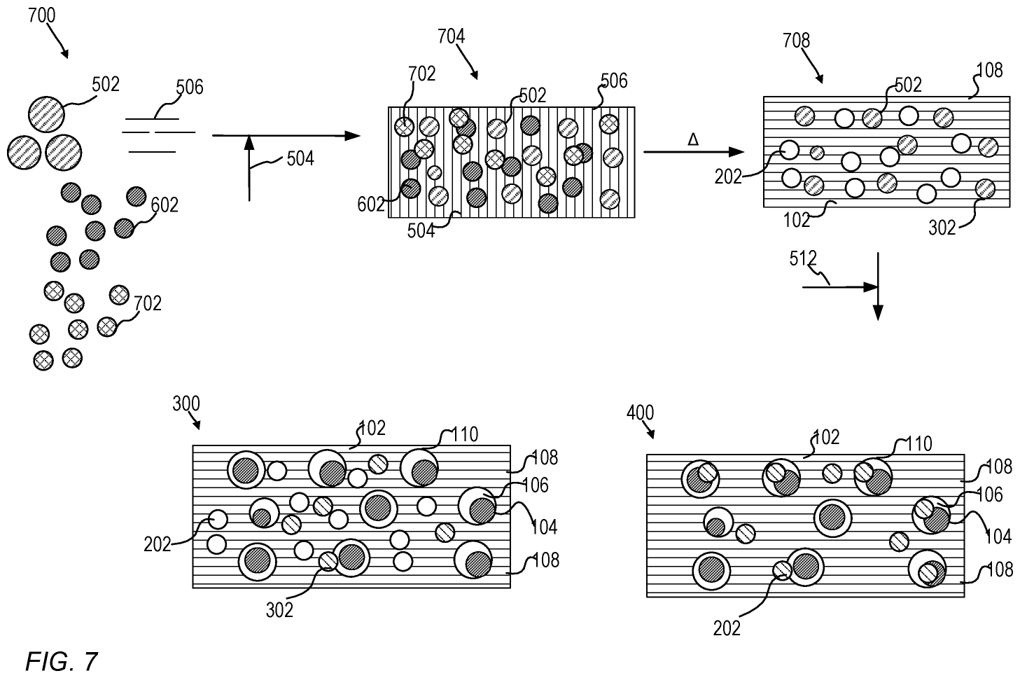

FIG. 7 depicts a method to produce a porous carbon-based film of the present invention with the porous carbon-based matrix containing mesopores and having a plurality of graphene structures attached to the porous carbon-based matrix, a plurality of elemental sulfur structures encompassed in a hollow space of the carbon-based matrix, and a plurality of polysulfide trapping agents. In method 700, elemental sulfur precursor materials 502 (e.g., ZnS), graphene material 506 (e.g., graphene oxide), organic polymer 504, macropore-forming materials 602 (e.g., LiNO₃), and polysulfide trapping agent precursor materials 702 can be obtained as described in the Materials Section and dispersed with in a polar solvent (e.g., dimethylformamide). The resulting dispersion can be subjected to conditions to produce a film. For example, a casting process can be used. In some embodiments, the elemental sulfur precursor materials 502 are coated with the polysulfide trapping agent precursor materials 702. Such a coating can provide polysulfide trapping agents in voids 106 and on elemental sulfur yolks 104 of the produced porous carbon-based film 400. In a casting process, the dispersion can be cast or poured or coated onto a carrier substrate or mold (e.g., a glass ring) and the solvent can be removed (e.g., evaporated) to create a solid layer (e.g., film) on the carrier substrate. The carrier substrate can be removed to produce a standalone film 704 having graphene materials in the matrix, and elemental sulfur precursor materials 502, polysulfide trapping agent precursor materials, and macropore-forming materials 602 embedded in the organic polymer matrix 504. The resulting mixed matrix film 704 can be subjected to conditions sufficient to carbonize the organic polymer to form a porous carbon-based matrix 102, convert graphene materials to graphene structures and attach the graphene structures to the formed porous carbon-based matrix, form macropores 202 from macropore-forming materials 602, and convert polysulfide trapping agent precursor material 702 to polysulfide trapping agents 302, thereby forming porous carbon-based film 708. Porous carbon-based film 708 can include a mesoporous and macroporous carbon-based matrix 102 that has graphene structures 108 attached to the matrix, polysulfide trapping agents 302, and elemental sulfur precursor materials 502 embedded in the matrix. For example, the mixed matrix film 704 can be heat-treated to 250° C. to 350° C., or 300° C. at a rate 1 to 5 or 2° C. per min under air and kept for a period of time (e.g., 1 to 5 h or 2 h) for pre-oxidation. The atmosphere can be changed to an inert atmosphere (e.g., argon), and the film can be heated from at least, equal to or between any two of 300° C. and 800° C. at rate of 1 to 10 or 5° C./min and kept until the porous carbon-based matrix is formed (e.g., 3 to 10 h, or 4 h), polysulfide trapping agents precursor material is converted to polysulfide trapping agents, macropores are formed, and the graphene materials are converted to graphene structures and attached to the porous carbon-based matrix.

Porous carbon-based film 708 can be contacted with a sulfur oxidizing solution 512 to convert elemental sulfur precursor materials 502 to elemental sulfur yolks 104 and form void spaces 106 in the porous carbon-based matrix 102, thereby forming multiple yolk-shell structures in the porous carbon-based matrix. Reduction of the metal sulfides to elemental sulfides produces a smaller compound thereby forming void spaces 106 in the carbon-containing matrix. By way of example, porous carbon-based film 708 can be mixed with an aqueous ferric nitrate solution. The resulting suspension can be agitated with cooling for a time sufficient to allow the iron to react with the zinc sulfide as described above. Mineral acid (e.g., hydrochloric acid) can be added to the film to remove any remaining zinc sulfide. The porous carbon-based film can be washed several times in deionized water, and then was dried at 60° C. to 80° C. or about 70° C. until dry (about 2 to 10 hours, or 3 to 5 hours). The resulting porous carbon-based film 300 and/or 400 can include elemental sulfur yolks 104 comprised in void spaces 106 of porous carbon-based matrix 102 containing macropores 202 and polysulfide trapping agents 302. Graphene structures 108 can be attached to the porous carbon-based matrix. In some embodiments, the plurality of graphene structures can be embedded in or grafted to the porous carbon-based matrix. In some embodiments, the macropore-forming agent is not necessary to form porous carbon-based films having elemental sulfur yolks and polysulfide trapping agents with graphene structures attached to the carbon-based matrix.

In some embodiments, graphene structures 108 are not used. Methods described throughout the specification for films containing graphene structures and methods exemplified in the Examples section can be used to make the porous carbon-based films of the present invention absent of graphene structures. FIG. 8 depicts a non-limiting method to produce a porous carbon-based film of the present invention with the porous carbon-based matrix containing mesopores, a plurality of elemental sulfur structures encompassed in a hollow space of the carbon-based matrix, and a plurality of polysulfide trapping agents. In method 800, elemental sulfur precursor materials 502 (e.g., ZnS), organic polymer 504, macropore-forming materials 802 (e.g., PVP), and polysulfide trapping agent material 804 (e.g., TiO₂) can be obtained as described in the Materials Section and dispersed with in a polar solvent (e.g., DMF). The resulting dispersion can be subjected to conditions to produce a film as previously described. For example, a casting process can be used. In a casting process, the dispersion can be cast or poured or coated onto a carrier substrate or mold (e.g., a glass ring) and the solvent can be removed (e.g., evaporated) to create a solid layer (e.g., film) on the carrier substrate. The carrier substrate can be removed to produce a standalone film 806 having elemental sulfur precursor materials 502, polysulfide trapping agents 804, and macropore-forming materials 802 embedded in the organic polymer matrix 808. As shown, the elemental sulfur precursor materials 502 are encapsulated by the organic polymer 504. Resulting mixed matrix film 806 can be subjected to conditions sufficient to carbonize the organic polymer to form a porous carbon-based matrix 102, form macropores 202 from macropore-forming materials 802, thereby forming porous carbon-based film 810. Porous carbon-based film 810 can include a mesoporous and macroporous carbon-based matrix 102 that has polysulfide trapping agents 804, and elemental sulfur precursor materials 502 embedded in the matrix. For example, the mixed matrix film 810 can be heat-treated to 250° C. to 350° C., or 300° C. at a rate 1 to 5 or 2° C. per min under air and kept for a period of time (e.g., 1 to 5 h or 2 h) for pre-oxidation. The atmosphere can be changed to an inert atmosphere (e.g., argon), and the film can be heated from at least, equal to or between any two of 300° C. and 800° C. at rate of 1 to 10 or 5° C./min and kept until the porous carbon-based matrix is formed (e.g., 3 to 10 h, or 4 h) and macropores are formed.

Porous carbon-based film 810 can be contacted with a sulfur oxidizing solution 512 to convert elemental sulfur precursor materials 502 to elemental sulfur yolks 104 and form void spaces 106 in the porous carbon-based matrix 808, thereby forming multiple yolk-shell structures in the porous carbon-based matrix. Reduction of the metal sulfides to elemental sulfides produces a smaller compound thereby forming void spaces 106 in the carbon-containing matrix and forms a porous yolk-shell structure polymer matrix 812. By way of example, porous carbon-based film 810 can be mixed with an aqueous ferric nitrate solution. The resulting suspension can be agitated with cooling for a time sufficient to allow the iron to react with the zinc sulfide as described above. Mineral acid (e.g., hydrochloric acid) can be added to the film to remove any remaining zinc sulfide. The porous carbon-based film can be washed several times in deionized water, and then was dried at 60° C. to 80° C. or about 70° C. until dry (about 2 to 10 hours, or 3 to 5 hours). The resulting porous carbon-based film 812 can include elemental sulfur yolks 104 comprised in void spaces 106 of porous carbon-based matrix 102 containing macropores 202 and polysulfide trapping agents 804. In some embodiments, the macropore-forming agent is not necessary to form porous carbon-based films having elemental sulfur yolks and polysulfide trapping agents with graphene structures attached to the carbon-based matrix.

D. Uses of the Porous Carbon-Containing Material with Yolk-Shell Structure

The porous carbon-containing materials of the present invention can be used in a variety of energy storage applications or devices (e.g., fuel cells, batteries, supercapacitors, electrochemical capacitors, lithium-ion battery cells or any other battery cell, system or pack technology), optical applications, and/or controlled release applications. The term “energy storage device” can refer to any device that is capable of at least temporarily storing energy provided to the device and subsequently delivering the energy to a load. Furthermore, an energy storage device may include one or more devices connected in parallel or series in various configurations to obtain a desired storage capacity, output voltage, and/or output current. Such a combination of one or more devices may include one or more forms of stored energy. By way of example a lithium ion battery can include the previously described porous carbon-containing material or multi-yolk/porous carbon-containing material (e.g., on an anode electrode and/or a cathode electrode). In another example, the energy storage device can include other technologies for storing energy, such as devices that store energy through performing chemical reactions (e.g., fuel cells), trapping electrical charge, storing electric fields (e.g., capacitors, variable capacitors, ultracapacitors, and the like), and/or storing kinetic energy (e.g., rotational energy in flywheels). In some embodiments, the article of manufacture is a virtual reality device, an augmented reality device, a fixture that requires flexibility such as an adjustable mounted wireless headset and ear buds, a communication helmet with curvatures, a medical patch, a flexible identification card, a flexible sporting good, a packaging material and applications where the energy source can simply final product design, engineering and mass production.

In some instances, the flexible composites of the present invention can enhance energy density and flexibility of flexible supercapacitors (FSC). The resultant flexible composites can include an open two-dimensional surface of graphene that can contact an electrolyte in the FSC. Moreover, the conjugated π electron (high-density carrier) of graphene can minimize the diffusion distances to the interior surfaces and meet fast charge-discharge of supercapacitors. Further, micropores of the composites of the present invention can strengthen the electric-double-layer capacitance, and mesopores can provide convenient pathways for ions transport.

### EXAMPLES

The present invention will be described in greater detail by way of specific examples. The following examples are offered for illustrative purposes only, and are not intended to limit the invention in any manner. Those of skill in the art will readily recognize a variety of noncritical parameters, which can be changed or modified to yield essentially the same results.

Instrumentation. SEM images were obtained using a FEI Nova NanoSEM™ (ThermoFisher Scientific, U.S.A.). Optical images were taken using a cellphone camera (Samsung A7). Energy dispersive X-ray (EDX) was obtained using a the FEI Nova NanoSEM operated at 10-20 kV. X-ray diffraction (XRD) were obtained using a powder PANalytical Empyrean diffractometer (PANalytical, The Netherlands). Thermogravimetric analysis (TGA) was obtained using a TGA Q500 (TA Instruments, U.S.A.) from 25 to 800° C. with a heat ramp of 10° C./min under nitrogen atmosphere.

### Example 1

### Preparation of ZnS Nanoparticles

The procedure of Ding et al., (Journal of Materials Chemistry A, 2015, 3:1853-1857) was followed to prepare zinc sulfide (ZnS) nanoparticles. Zinc acetate dehydrate (0.04 mol, Sigma-Aldrich®) and thiourea (0.08 mol, Sigma-Aldrich®) were dissolved in deionized water (400 mL) and added into a polytetrafluoroethylene bottle. Gum arabic (6 g, Sigma-Aldrich®) was added as a surfactant for the formation of the spheres. The solution was stirred and sonicated to ensure complete dissolution of the reagents and then the bottle was added to a polytetrafluoroethylene lined autoclave. The autoclave was sealed and placed into an oven at about 120° C. for 15 hours. The resulting white zinc sulfide precipitate was isolated via centrifugation, and washed three times.

### Example 2

### Preparation of Al(OH)₃

The procedure of Goudarzi et al., (Journal of Cluster Science, 2015, 27:25-38) was followed to prepare Al(OH)₃ and Al₂O₃ nanoparticles. Al(NO₃)₃.9H₂O (3 g, Sigma-Aldrich®) was dissolved in 100 mL of distilled water. Ethylenediamine as a precipitation agent was added until the pH of the solution was adjusted to 8. A white precipitate was obtained, which confirmed the synthesis of Al(OH)₃. The precipitate of Al(OH)₃ was centrifuged, rinsed with distilled water, and dispersed in N,N-dimethylformamide (DMF).

### Example 3

### Preparation of Polymer-Based Matrix Film of the Present Invention

Graphene oxide (0.01 g) as a graphene material precursor, Al(OH)₃ (1 mL, 0.02 g/ml in DMF) as polysulfide trapping agents, Li₂CO₃ (0.2 g) as a macropore-forming agent, ZnS nanoparticles (0.5 g) as elemental sulfur precursor material, and polyacrylonitrile (1 g) as a carbon-based matrix precursor were mixed in anhydrous DMF (15 mL). The solution was dispersed and degassed using a Sonic Dismembrator (Fisher Scientific, U.S.A). After degassing, the mixture was cast in a steel ring with glass plate and the solvent was evaporated at room temperature. The resulting film was dried at 80° C. for 48 hours under vacuum to produce a polymer-based matrix film that includes, sulfur-trapping agents, zinc sulfide nanostructures and graphene oxide structures.

### Example 4

### Preparation of Porous Carbon-Based Matrix Film of the Present Invention

The polymer-based matrix film from Example 3 was sandwiched between alumina plates, loaded into a tubular furnace, and heated from room temperature to 300° C. at 2° C./min under air and held for 2 hours for pre-oxidation. The atmosphere was then changed to argon and the sandwiched film was further heated from 300° C. to 800° C. at 5° C./min and held for 4 hours to provide a carbonized porous polymer matrix that encompasses zinc sulfide nanostructures and includes graphene structures. The carbonized porous matrix include mesopores formed by the carbonization process.

### Example 5

### Preparation of Porous Carbon-Based Matrix Film with Elemental Sulfur Yolks

The obtained porous carbon-based matrix film from Example 4 was immersed in ferric nitrate solution (20 mL, 2 M in water) with gentle stirring in an ice-water bath for 15 hours. Afterward, the film was immersed in hydrochloric acid (0.1 M) to remove any remaining zinc sulfide. The film was then washed several times in deionized water and dried in an oven at 70° C. for 3 hours to produce a porous carbon-based film that includes a porous carbon-based matrix containing a plurality of elemental sulfur yolks, a plurality of graphene structures attached to the porous carbon-based matrix, and polysulfide trapping agents dispersed in the matrix. The sulfur yolks were positioned within a hollow space in the porous carbon-based matrix (shell).

### Example 6

### Preparation Characterization of Polymer-Based Matrix Film of the Present Invention

Preparation of Polymer-Based Matrix Film of the Present Invention:

Polyacrylonitrile (PAN, 1.45 g, Mw=150,000, Sigma-Aldrich®, U.S.A.) and polyvinylpyrrolidone (PVP, 0.05 g, Mw=360,000, Sigma-Aldrich®) were dissolved in N,N-dimethylformamide (DMF, 50 mL, Sigma-Aldrich®) and then mixed with TiO₂ (0.2 g, 21 nm, Sigma-Aldrich®) and ZnS (5 g, 5 micron, Sigma-Aldrich®) using ultrasonic mixing. The resulting mixture was cast in polytetrafluoroethylene beaker and heated at 45° C. for 2 days. The resulted film was dried under vacuum at 90° C. overnight and labeled ZnS@TiO₂@PAN.

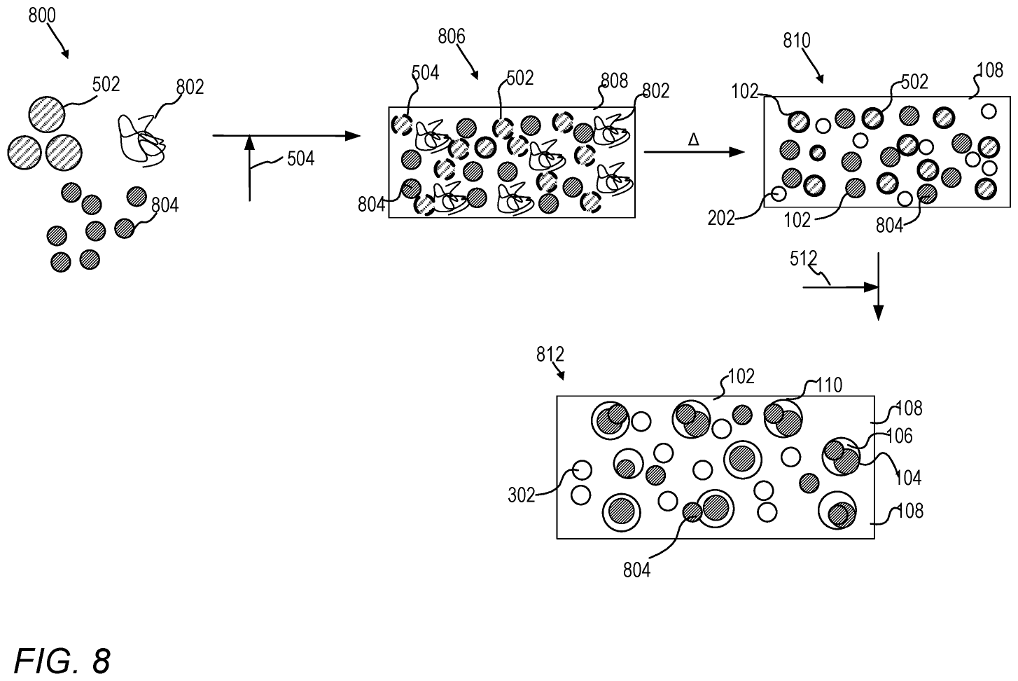

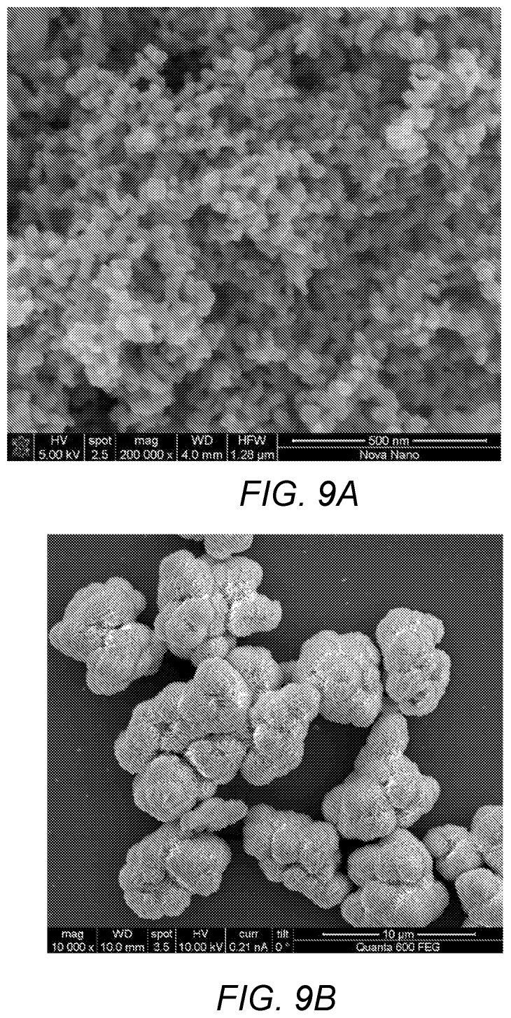

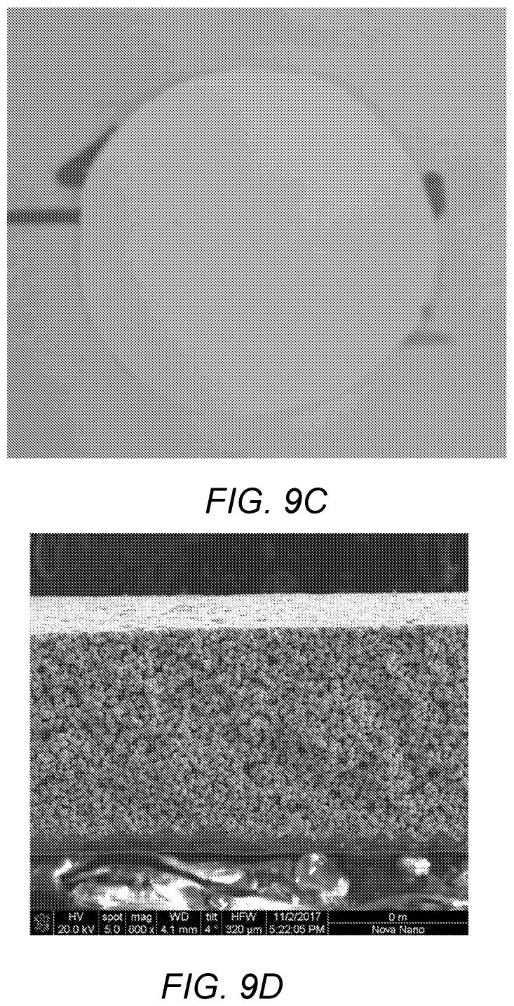

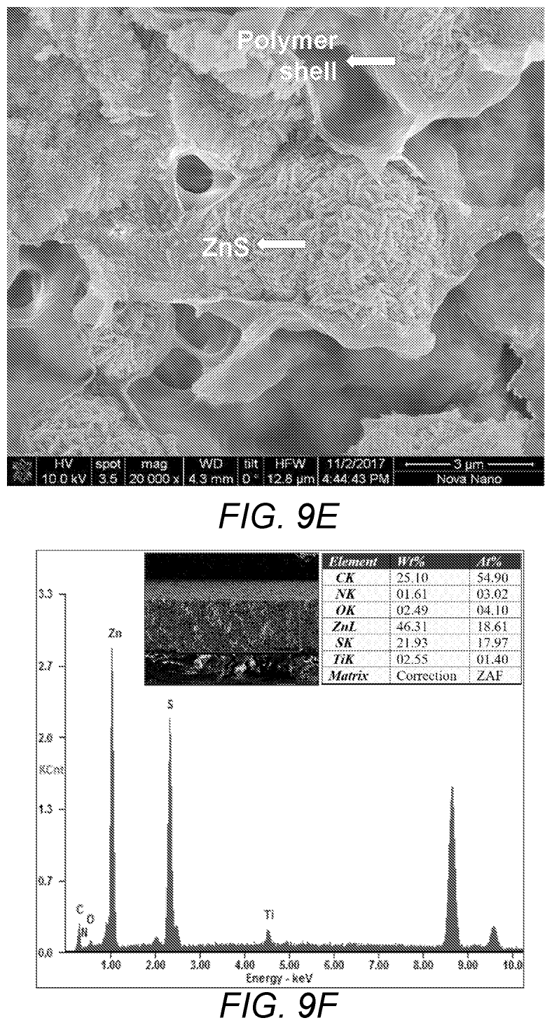

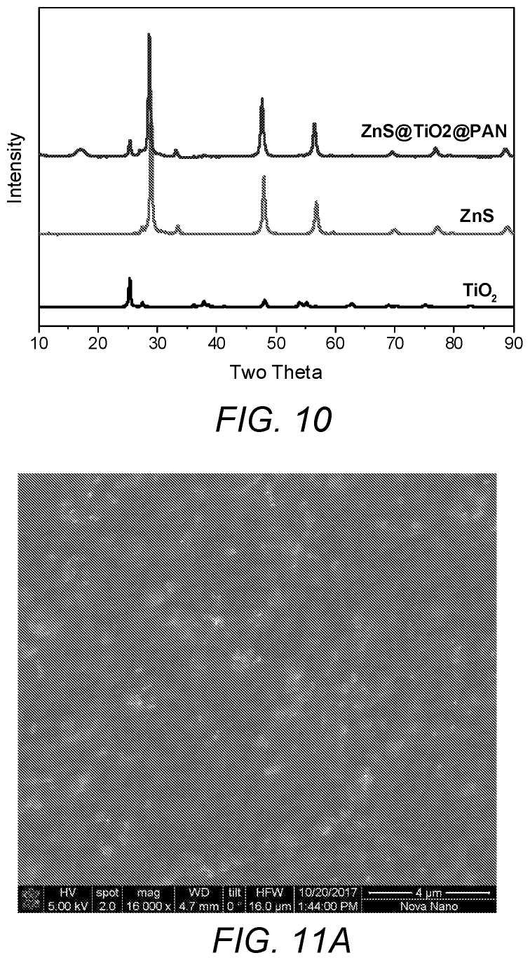

Characterization of ZnS@TiO₂@PAN. FIG. 9A is a SEM image of TiO₂ nanoparticles polysulfide trapping agents. FIG. 9B is a SEM image of ZnS particle, which is the precursor for sulfur. FIG. 9C is the optical image of ZnS@TiO₂@PAN film. FIG. 9D is the SEM image of a cross-section of the ZnS@TiO₂@PAN film. The thickness was around 176 μm. FIG. 9E is the magnified SEM image of FIG. 9D. It was determined from the SEM that ZnS particles were encapsulated by the polymer shell. The EDX of ZnS@TiO₂@PAN film is shown in FIG. 9F. The weight ratio of C:N:O:Zn:S:Ti was 25.1:1.61:2.49:46.31:21.93:2.55. FIG. 10 are XRD patterns of ZnS particles, TiO₂ particles, and the ZnS@TiO₂@PAN film of the present invention. From the XRD patterns, it was determined that the ZnS and TiO₂ was included in the matrix film as the ZnS and TiO₂ peaks are present in the XRD pattern.

### Example 7

### Preparation and Characterization of the Porous Carbon-Based Matrix Film of the Present Invention

Preparation. The polymer-based matrix film from Example 6 was sandwiched between graphite plates, loaded into a tubular furnace, and heated from room temperature to 240° C. at 5° C./min under air and held for 2 hours for pre-oxidation. The atmosphere was then changed to nitrogen gas and the sandwiched film was further heated from 240° C. to 650° C. at 3° C./min and held for 2 hours to provide a carbonized porous polymer matrix that encompasses zinc sulfide nanostructures. PVP was used as pore former, which was remove by calcination to form mesopores. The carbonized porous matrix includes mesopores formed by the carbonization process and labeled ZnS@TiO₂@C.

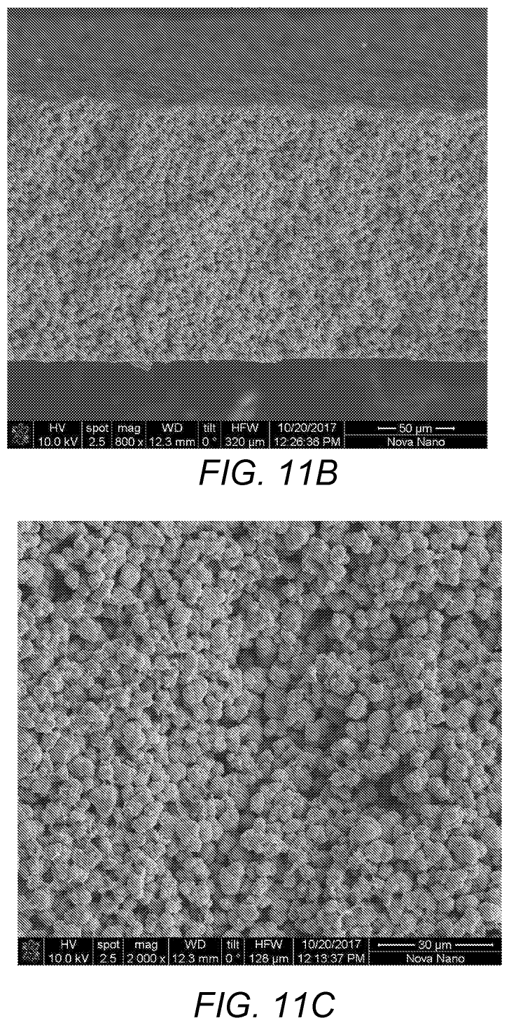

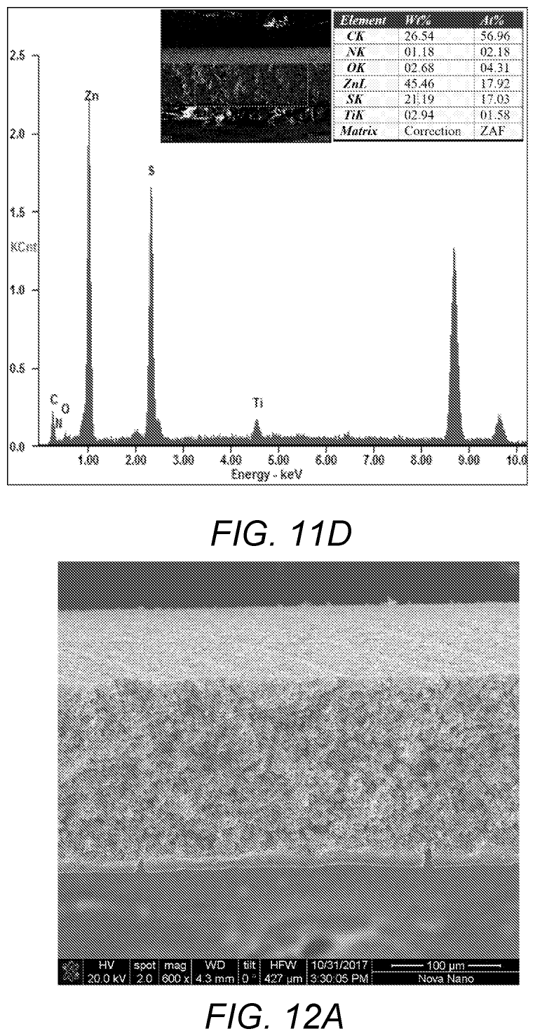

Characterization of ZnS@TiO₂@C of the present invention. FIG. 11A is a top view SEM image of ZnS@TiO₂@C of the present invention. FIGS. 11B and 11C are the SEM cross-sectional image and magnified cross-sectional view of the ZnS@TiO₂@C. FIG. 11D is the EDX of the ZnS@TiO₂@C. The weight ratio of C:N:O:Zn:S:Ti was 26.54:1.18:2.68:45.46:21.19:2.94.

### Example 8

### Preparation and Characterization of Porous Carbon-Based Matrix Film with Elemental Sulfur Yolks

Preparation. The obtained porous carbon-based matrix film from Example 7 was immersed in ferric nitrate solution (20 mL, 2 M in water) with gentle stirring in an ice-water bath for 15 hours. Afterward, the film was immersed in hydrochloric acid (0.1 M) to remove any remaining zinc sulfide. The film was then washed several times in deionized water and dried in an oven at 70° C. for 3 hours to produce a porous carbon-based film that includes a porous carbon-based matrix containing a plurality of elemental sulfur yolks and polysulfide trapping agents dispersed in the matrix. The final film was labeled S@TiO₂@C. The sulfur yolks were positioned within a hollow space in the porous carbon-based matrix (shell).

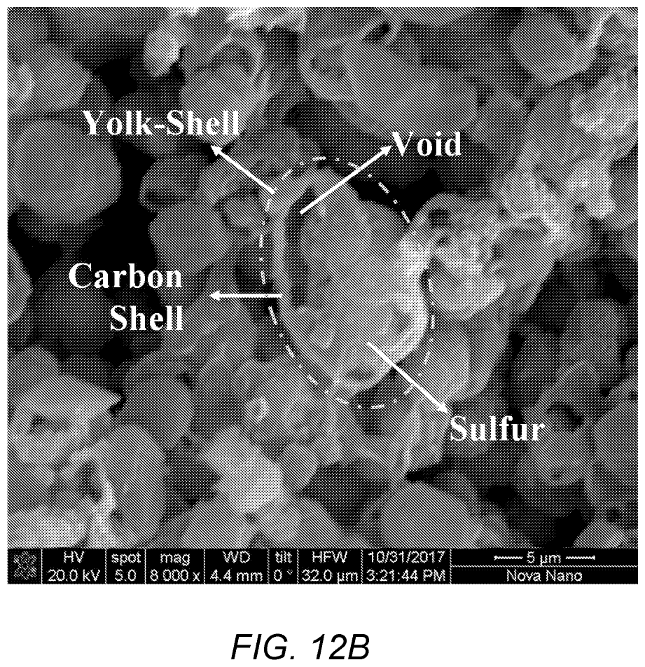

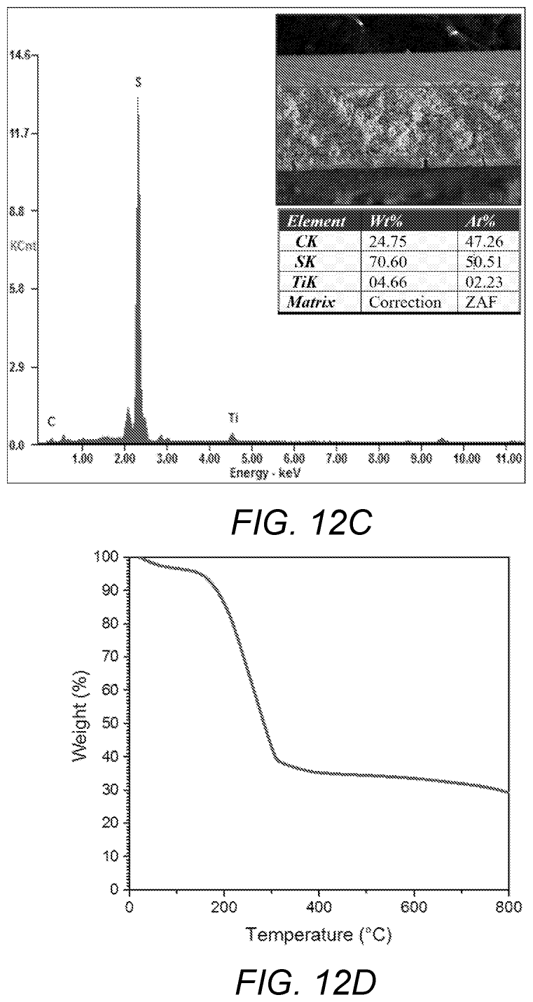

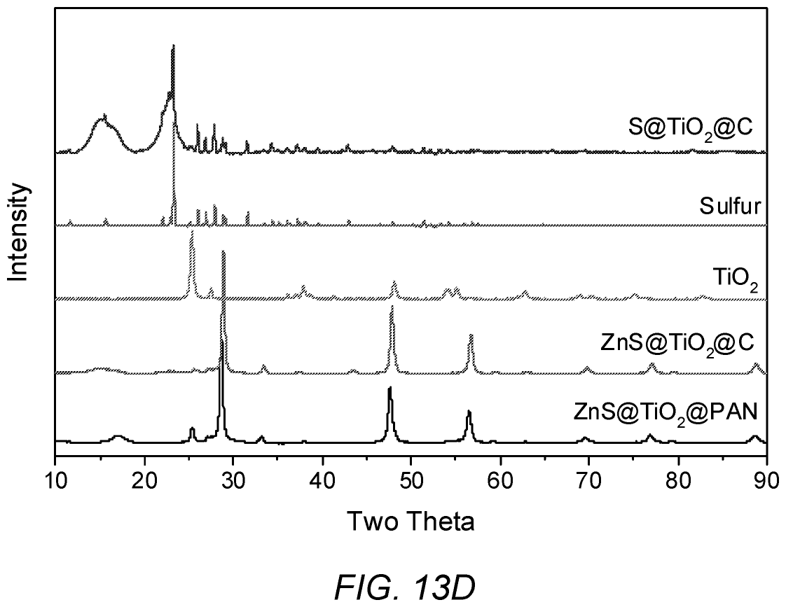

Characterization. FIG. 12A is the SEM cross-sectional image of the S@TiO₂@C film of the present image. FIG. 12B is the magnified view of FIG. 12A. These images show that a sulfur@carbon yolk-shell was formed. FIG. 12C is EDX spectra of the S@TiO₂@C film, which shows element Zinc has been removed. Thus, the zinc sulfide was oxidized into sulfur. Using TGA, it was determined that the sulfur was formed in the S@TiO₂@C film (See, FIG. 12D) as a sharp change in slope at about 350° C. was observed and matched known TGA data of sulfur. The weight ratio of sulfur was approximately 65%. FIG. 13 are the XRD patterns of the S@TiO₂@C film of the present invention, sulfur, TiO₂, ZnS@TiO₂@C film of the present invention and ZnS@TiO₂@PAN film of the present invention. From the comparison of XRD patterns, it was determined that the ZnS disappeared and sulfur was formed after Fe(NO₃)₃ oxidation.

1. A porous carbon-based film that includes a porous carbon-based matrix comprising:
(a) a plurality of yolk-shell type structures, each yolk-shell type structure comprising an elemental sulfur nanostructure positioned within a hollow space of the porous carbon-based matrix; and
(b) a plurality of graphene structures attached to the porous carbon-based matrix.

2. The porous carbon-based film of claim 1, wherein the porous carbon-based matrix comprises mesopores.

3. The porous carbon-based film of claim 2, wherein the mesopores have a diameter of 2 to 50 nm.

4. The porous carbon-based film of claim 2, wherein the porous carbon-based matrix also includes macropores having a diameter of 50 to 1000 nm.

5. The porous carbon-based film of claim 1, wherein the matrix further comprises a polysulfide trapping agent embedded in the porous carbon-based matrix, contained in the hollow space, or in contact with the elemental sulfur nanostructure, or any combination thereof.

6. The porous carbon-based film of claim 5, wherein the polysulfide trapping agent is a metal oxide selected from MgO, Al₂O₃, CeO₂, La₂O₃, SₙO₂, Ti₄O₇, TiO₂, MnO₂, or CaO, or any combination thereof.

7. The porous carbon-based film of claim 1, wherein the hollow space allows for volume expansion of the elemental sulfur nanostructure without deforming the porous carbon-based matrix.

8. The porous carbon-based film of claim 1, wherein the film is binder-free.

9. The porous carbon-based film of claim 1, wherein the plurality of graphene structures are embedded in or grafted to the porous carbon-based matrix.

10. An energy storage device comprising the porous carbon-based film of claim 1.

11. The energy storage device of claim 10, wherein the energy storage device is a rechargeable battery.

12. The energy storage device of claim 10, wherein the porous carbon-based film is comprised in an electrode of the energy storage device.

13. A method of making the porous carbon-based film of claim 1, the method comprising:
(a) obtaining a composition comprising an organic solvent, an organic polymer, a plurality of graphene oxide structures, and a plurality of metal sulfide nanostructures;
(b) forming a precursor film from the composition, the precursor film comprising an organic polymer matrix, the plurality of graphene oxide structures, and the plurality of metal sulfide nanostructures;
(c) heat treating the precursor film to (i) convert the graphene oxide structures to graphene structures and (ii) form a porous carbon-based matrix from the organic polymer matrix; and
(d) subjecting the heated-treated precursor film to conditions sufficient to oxidize the metal sulfide nanostructures to form elemental sulfur nanostructures comprised within hollow spaces of the porous carbon-based matrix,
wherein the porous carbon-based film of claim 1 is obtained.

14. The method of claim 13, wherein:
step (b) comprises casting the composition, evaporating the organic solvent to form the precursor film, and drying the precursor film; and
step (c) comprises heating the precursor film to 300° C. to 1000° C. in an inert atmosphere for 2 to 12 hours.

15. The method of claim 13, wherein the organic polymer is polyacrylonitrile, polydopamine, polyalkylene, polystyrene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof.

16. The method of claim 13, wherein the plurality of metal sulfide nanostructures are ZnS, CuS, MnS, FeS, CoS, NiS, PbS, Ag₂S, or CdS, or any combination thereof.

17. The method of claim 13, wherein the composition in step (a) further comprises a macropore-forming agent, a polysulfide trapping agent precursor, or both.

18. The method of claim 17, wherein, during heat treating step (c), the macropore-forming agent is removed from the precursor film, the polysulfide trapping agent precursor is formed into a polysulfide trapping agent, or a combination thereof.

19. The method of claim 17, wherein the macropore-forming agent is a metal oxide, a metal salt, or a metal hydroxide selected from Li₂O, ZnO, Li₂CO₃, LiCl, LiNO₃, LiOH, K₂CO₃, or LiCO₃, or any combination thereof, the polysulfide trapping agent precursor is Mg(OH)₂, Al(OH)₃, Ce(OH)₃, La(OH)₃, Ti(OH)₄, or Ca(OH)₂ or any combination thereof, or both.

20. The method of claim 19, wherein the polysulfide trapping agent precursor is converted to MgO, Al₂O₃, CeO₂, La₂O₃, SnO₂, Ti₄O₇, TiO₂, MnO₂, or CaO, or any combination thereof.
